(19) United States
(12) Patent Application Publication
(10) Pub. No.: US 2022/0294304 A1
(43) Pub. Date: Sep. 15, 2022

(54) ELECTRIC MACHINE

(71) Applicant: JHEECO E-DRIVE AG, Eschen (LI)

(72) Inventor: Markus MICHAEL, Altstätten (CH)

(21) Appl. No.: 17/637,043

(22) PCT Filed: Aug. 26, 2020
(86) PCT No.: PCT/EP2020/073843

§ 371 Date: Feb. 21, 2022

(30) Foreign Application Priority Data
Aug. 27, 2019 (DE) 10 2019 122 944.8

(51) Int. Cl. H02K 5/15; H02K 7/00; H02K 7/04; H02K 9/12; H02K 9/19; H02K 17/16

(52) U.S. Cl. CPC H02K 5/15; H02K 7/003; H02K 7/04; H02K 9/12; H02K 9/19; H02K 17/165

(57) ABSTRACT

The invention relates to an electric machine which is cooled or can be cooled by a fluid, comprising a rotor, a stator, and at least one end disk which are arranged in a housing, where the end disk and the rotor are arranged on a shaft, in particular a hollow shaft, and the end disk is arranged on at least one axial end of the rotor, where at least one first fluid region is formed between a first face side of the end disk and at least one axial end of the rotor and a second fluid region between a second face side of the end disk and the housing, where the two fluid regions comprise at least one outer fluid connection and at least one inner fluid connection which each connect the two fluid regions to one another such that the fluid can circulate at least in sections between the first and the second fluid region.

The invention relates to an electric machine according to the features of the preamble of claim 1.

When operating electric machines, very high temperatures arise at the rotor. This is the case in particular with electric machines that are designed for high rotational speeds. The effectively usable cooling surface of the rotors is very limited due to the design. An air gap, which is configured to be as small as possible, is arranged between the rotor and the stator. It is therefore hardly possible to use the outer surface of the rotor as a cooling surface. Cooling therefore takes place substantially over the face sides of the rotor.

DE 11 2012 004 272 T5 discloses an electric machine with a rotor configured as a drum motor which is arranged on a shaft and around which a stator is arranged concentrically. In the aforementioned electric machine, blades are arranged on one face side of the rotor. The blades generate a flow of cooling air which flows through gaps at the coil ends of the stator. A drawback of the electric machine described is that drag losses that are too high arise at high rotational speeds due to the blades.

A further electric machine is known from JP 2009 273 288 45 A. In this electric machine, an end disk is arranged on a shaft at one face side of the rotor. The end disk comprises sections which each comprise radially on the inside an inlet for a cooling fluid. Furthermore, outlet openings are arranged in the sections. Coolant can be introduced into the sections and flows through the outlet openings onto the stator coils. This variant can be implemented only with great complexity. Furthermore, the above-mentioned electric machine is costly to implement.

The invention is therefore based on the object of specifying an electric machine in which the cooling is improved so that drag losses are reduced and applications with high rotational speeds are therefore possible.

With regard to the electric machine, this object is satisfied according to the invention by the object of claim 1.

The object is satisfied specifically by an electric machine that is cooled or can be cooled by a fluid. The electric machine comprises a rotor, a stator, and at least one end disk which are arranged in a housing, where the end disk and the rotor are arranged on a shaft, in particular a hollow shaft, and the end disk is arranged on at least one axial end of the rotor. At least one first fluid region is formed between a first face side of the end disk and an axial end of the rotor and a second fluid region between a second face side of the end disk and the housing, where the two fluid regions comprise at least one outer fluid connection and at least one inner fluid connection which each connect the two fluid regions to one another such that the fluid can circulate at least in sections between the first and the second fluid region.

Balancing disks, short-circuit rings and/or cover disks are possible as end disks. Balancing disks are to be understood to mean disk-shaped devices for balancing the rotor. Mass-neutral, positive (add material), or negative (remove material) balancing can be used for balancing. Short-circuit rings are the connecting elements on the front end of the rotor for short-circuit rods disposed in axial slots to form a short-circuit cage of a squirrel-cage rotor (asynchronous machine/ASM). Several short-circuit rings spaced from one another can be provided. Cover disks are disks attached to the end of a laminated sheet package of the rotor for axially holding magnets inserted in rotor slots (for permanent magnet machines/PSM).

The first end disk is preferably configured as a balancing disk. The second end disk preferably comprises short-circuit rings and/or cover disks. It is conceivable that the electric machine comprises several second end disks which are arranged between a first end disk and the rotor.

The invention has the following advantages. The inner and outer fluid connection enables the cooling fluid to circulate. The inner fluid connection rotates with the shaft and the rotor. The flow is generated by the centripetal force of the rotating electric machine. More precisely, the cooling fluid is ring-shaped at least in sections in a longitudinal sectional view of the housing. In other words, a ring-shaped vortex flow is created. The first and the second face sides of the end disk, in particular of the balancing disk, comprise a contact surface with the vortex flow. In order to obtain the largest possible contact surface, it is advantageous to have the distance between the inner and the outer fluid connection be as large as possible. The circulating flow on both sides of the end disk improves convection. Furthermore, the use of additional air conveying devices such as, for example, blades can then be dispensed with. Drag losses during operation are prevented or reduced in this way.

Preferred embodiments of the invention are specified in the dependent claims.

In a preferred embodiment, the outer fluid connection has an annular gap which is defined by the end disk and an inner surface of the housing. The annular gap is advantageous because it enables good circulation without disturbing edges.

In a further preferred embodiment, the outer fluid connection is arranged in the end disk. This is advantageous when mixing of cooling fluids is to be enabled.

It is advantageous to have the circulating fluid have an axial and/or radial direction at least in sections. This results in a ring-shaped flow that is in contact with both sides of the end disk, in particular the balancing disk, and cools it.

In a particular embodiment, the inner fluid connection extends at least in part between the face sides of the end disk. As a result, the two fluid regions are connected to one another having the shortest distance.

In a further particularly preferred embodiment, the shaft comprises a hollow shaft and the inner fluid connection extends at least in part in the hollow shaft. The hollow shaft has a cylindrical shape. The hollow shaft comprises, for example, a first bore in the first fluid region and a second bore in the second fluid region. The hollow shaft therefore comprises the inner fluid connection. The first and the second fluid regions are in fluid communication with one another due to the cylindrical shape of the hollow shaft.

It is further preferably possible for the hollow shaft to comprise recesses, in particular grooves, on the surface. The recesses are spaced from one another and are arranged in the region of the end disk such that the cooling fluid can flow through the recess between the end disk and the hollow shaft.

The electric machine further particularly preferably comprises a first end disk and at least one second end disk, where the first end disk is configured as a balancing disk and the second end disk as at least one short-circuit ring, in particular several stacked short-circuit rings. It is then possible to further enlarge the cooling surface and to cool the face side of the rotor more efficiently. The first end disk is preferably spaced from the at least one short-circuit ring. It is possible for the short-circuit rings to be spaced from one another. This allows the cooling fluid to circulate between the second end disks. The radii of the short-circuit rings preferably increase from axially inside to axially outside.

It is further advantageous to have spacers be arranged between the end disk and the rotor. The spacers make it possible for the distance between the end disk and the rotor to remain constant during operation when the temperature of the rotor rises. It is possible to use several end disks which are spaced from one another by spacers. They can be manufactured, for example, integrally from the same material as the end disks or integrally from a different material than the end disks, for example, plastic material that is molded onto the end disks. This ensures uniform spacing, i.e. gap, even with greatly differing thermal expansion of various rotor components, e.g. with the axial expansion of a squirrel cage in comparison to a balancing disk.

It is advantageous to have the inner fluid connection have different cross-sections and/or cross-sectional shapes. This is advantageous because the flow rate of the cooling fluid can be regulated or adjusted through the cross section and the cooling fluid impinges on the cooling surface at a greater velocity. The inner fluid connection can then be implemented as a jet or diffuser. In other words, the inner fluid connection can comprise a jet or diffuser. Furthermore, noises, in particular whistling, can be reduced by adapting the cross-sectional shape of the inner fluid connection.

In one embodiment, the fluid flows through the hollow shaft which comprises an outlet opening in the region of the end disk. The hollow shaft can be used as a supply for the cooling fluid. Furthermore, the rotor cooling can be combined via the outlet opening with the cooling of the hollow shaft.

It is advantageous to have the cooling fluid comprise a cooling gas, in particular air and/or a cooling liquid, in particular dielectric oil. This can improve the cooling performance. It is advantageous to have the cooling media remain separatable from one another or mixable, depending on the application.

In a further embodiment, the first end disk and/or the second end disk comprise an inclination, where the incline of the inclination of the first end disk in the direction of the rotor is positive and the incline of the inclination of the second end disk in the direction of the rotor is negative. It is possible due to the inclination of the first end disk to enhance the circulation of the cooling fluid. The inclination of the second end disk enables a self-evacuating air gap. The air gap corresponds to the axial gap between the stator and the rotor.

The invention shall be explained in more detail hereafter by way of embodiments with reference to the accompanying drawings, where:

FIG. 1 shows a sectional view through an electric machine according to an embodiment of the invention, in which the inner fluid connection is arranged in the end disk;

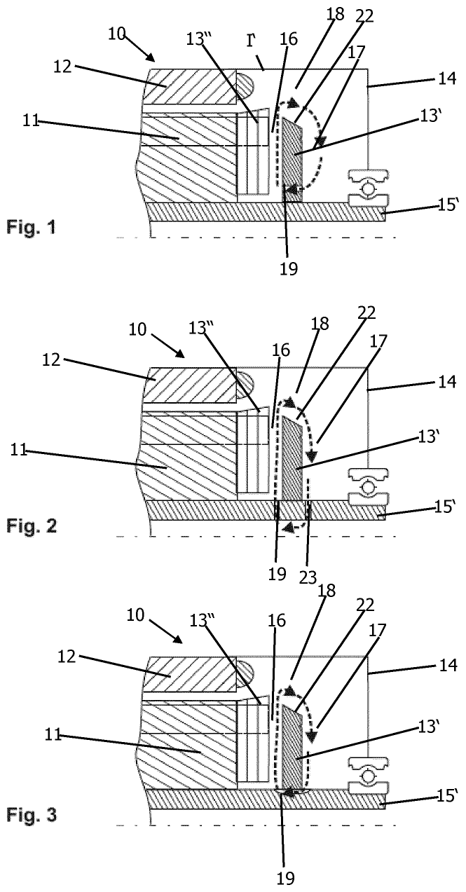

FIG. 2 shows a sectional view through an electric machine according to an embodiment of the invention, in which the inner fluid connection is arranged in the hollow shaft;

FIG. 3 shows a sectional view through an electric machine according to an embodiment of the invention, in which the inner fluid connection is arranged between the hollow shaft and the end disk;

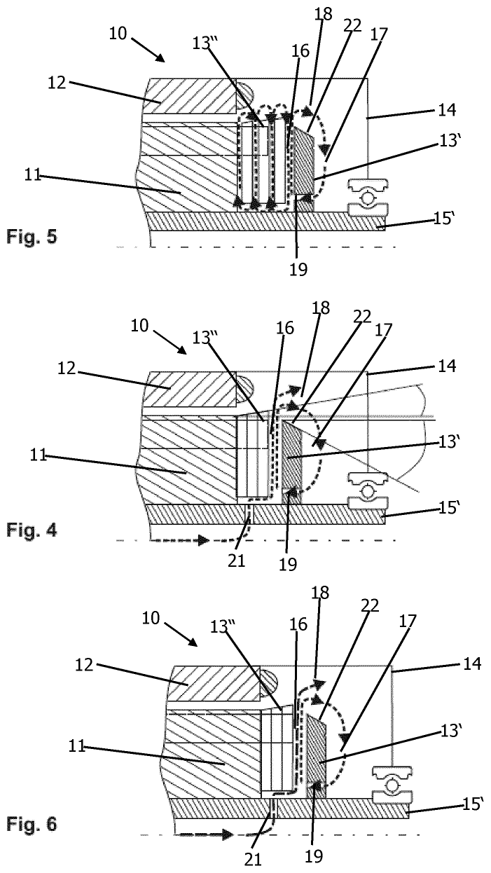

FIG. 4 shows a sectional view through an electric machine according to FIG. 1 with hollow shaft cooling;

FIG. 5 shows a sectional view through an electric machine according to FIG. 1 with spaced end disks;

FIG. 6 shows a sectional view through an electric machine according to FIG. 4 with two cooling media;

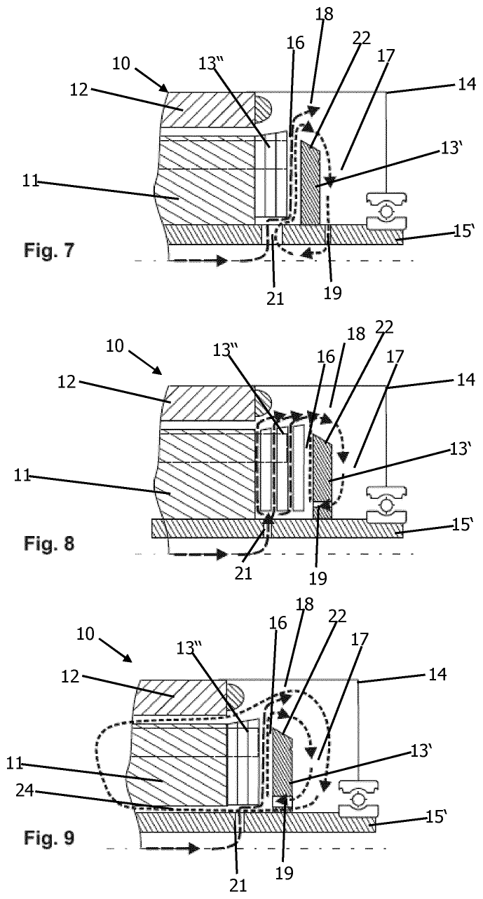

FIG. 7 shows a sectional view through an electric machine according to an embodiment of the invention with an enlarged outlet;

FIG. 8 shows a sectional view through an electric machine according to an embodiment of the invention with parallel air and oil cooling;

FIG. 9 shows a sectional view through an electric machine according to an embodiment of the invention with an axial cooling channel;

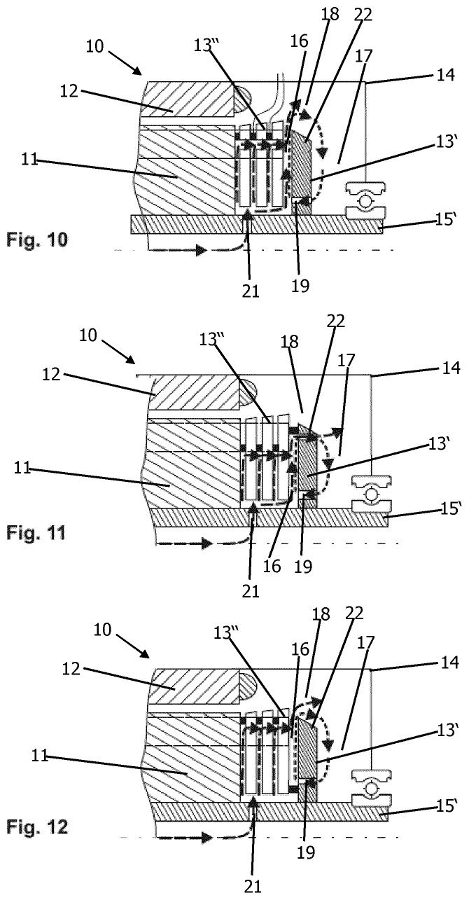

FIG. 10 shows a sectional view through an electric machine according to FIG. 8 with spacers;

FIG. 11 shows a sectional view through an electric machine according to FIG. 10 with an additional sealing element;

FIG. 12 shows a sectional view through an electric machine according to FIG. 10 with an additional sealing element;

FIG. 13 shows a perspective view of a rotor according to an embodiment of the invention;

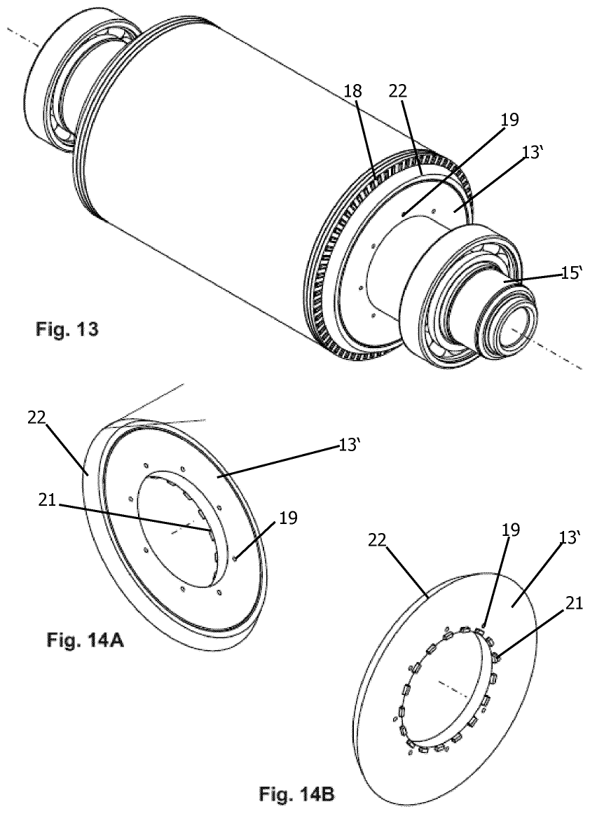

FIG. 14A shows a perspective view of an end disk according to an embodiment of the invention;

FIG. 14B shows a further perspective view of the end disk according to FIG. 14A, and

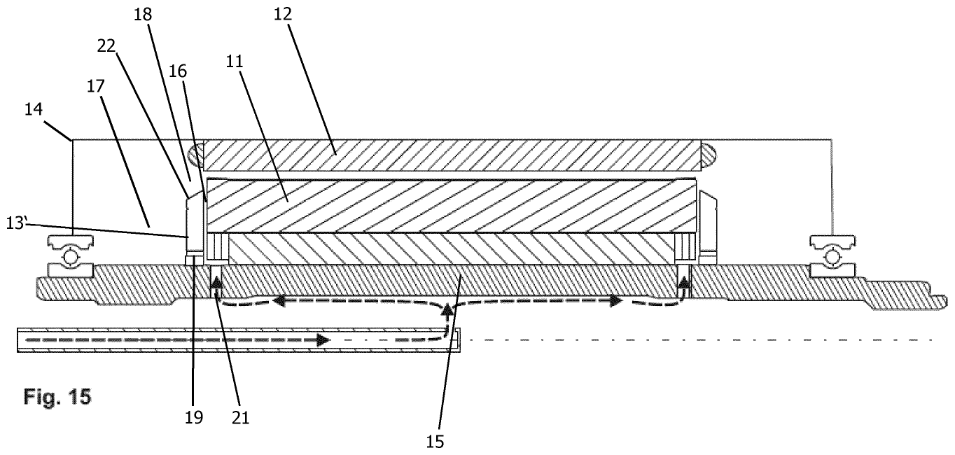

FIG. 15 shows a sectional view of an electric machine according to an embodiment of the invention with a fluid lance.

FIGS. 1 to 12 each show an embodiment of an electric machine 10. FIGS. 1 to 12 have the following features in common.

Electric machine 10 comprises a housing 14. A rotor 11, a stator 12, a first end disk 13′, in particular a balancing disk, several second end disks 13″, in particular short-circuit rings, and a hollow shaft are arranged coaxially in housing 14. A cooling medium can flow through housing 14.

Rotor 11 and end disks 13′, 13″ are fixedly arranged at the hollow shaft. Hollow shaft 15′ is mounted to be rotatable. First end disk 13′ is arranged between a face side of rotor 11 and housing 14. Second end disks 13″ are arranged between the rotor face side and first end disk 13′. The radius of first end disk 13 is smaller than the radius of rotor 11. A first fluid region 16 is formed between the face side of rotor 11 and first end disk 13′. A second fluid region 17 is formed between first end disk 13′ and housing 14.

First end disk 13′ comprises an inclination 22 radially on the outside. Inclination 22 is positive in the direction of rotor 11. In other words, the radius of first end disk 13′ on the side facing rotor 11 is greater than the radius on the side facing away from rotor 11. The radius increases in the direction of rotor 11.

Second end disk 13″ also comprises an inclination 22 radially on the outside. Inclination 22 of second end disk 13″ is negative in the direction of rotor 11. In other words, the radius of second end disk 13″ on the side facing rotor 11 is smaller than the radius on the side facing away from rotor 11. The radius decreases in the direction of rotor 11.

Stator 12 encloses rotor 11. An axially extending gap is formed between rotor 11 and stator 12.

The distinguishing features of the embodiments shall be discussed in greater detail hereafter.

FIG. 1 comprises several passage openings in first end disk 13′. The passage openings are arranged in the circumferential direction on first end disk 13′. The passage openings form an inner fluid connection 19. More precisely, inner fluid connection 19, with a view onto the outer fluid connection 18, is arranged radially inwardly.

An annular gap is formed between first end disk 13′ and the inner outer surface of housing 14. The annular gap forms an outer fluid connection 18 between first and second fluid region 16, 17. More precisely, the annular gap forms a radially outer fluid connection 18.

Air flows through the housing for cooling. The rotation of rotor 11 and the resulting centripetal force create a radial air flow The air flows radially outwardly in first fluid region 16. The air flows along a first face side of first end disk 13′ and along a face side of second end disk 13″. The air flows through the annular gap, i.e. the outer fluid connection 18, into second fluid region 17. The air flows radially inwardly in second fluid region 17. The air there flows along a second face side of first end disk 13′. The air flows back into first fluid region 16 through inner fluid connection 19.

The air circulates around first end disk 13′. The flow in the longitudinal sectional view is ring-shaped. The effective cooling surface of rotor 11 is increased in this manner. Furthermore, the convection is improved by the circulation of the air.

FIG. 2 shows an embodiment which corresponds substantially to that shown in FIG. 1. Unlike in FIG. 1, inner fluid connection 19 in FIG. 2 is not arranged in first end disk 13′. Hollow shaft 15′ comprises an outlet opening 21 between first end disk 13′ and rotor 11 and an inlet opening 23 between first end disk 13′ and housing 14. Inner fluid connection 19 is part of hollow shaft 15′. Inner fluid connection 19 extends from inlet opening 23 in second fluid region 17 through hollow shaft 15′ to outlet opening 21 in first fluid region 16. Unlike in FIG. 1, the circulation takes place through the openings in hollow shaft 15′.

FIG. 3 shows an embodiment which differs from the embodiments previously described only in the shape of the inner fluid connection. Grooves distributed over the circumference are arranged on the contact surface between first end disk 13′ and hollow shaft 15′. The axial width of the grooves is greater than the axial width of first end disk 13′. Cooling fluid can flow through the grooves. The grooves therefore form inner fluid connection 19 between the first and the second fluid region.

FIG. 4 shows an embodiment which comprises an inner fluid connection 19 according to FIG. 1. In addition, hollow shaft 15′ has its own cooling. The cooling of hollow shaft 15′ is connected to the cooling of rotor 11 via an outlet 22 which is arranged between first end disk 13′ and rotor 11.

The cooling fluid flows through outlet 22 from hollow shaft 15′ into fluid region 16. The cooling fluid of the hollow shaft cooling flows at least in sections parallel to the cooling fluid of the rotor cooling. It is possible for the two cooling fluids to mix with one another. The two cooling fluids can be the same or different cooling fluids.

FIG. 5 shows an electric machine 10 with an inner fluid connection according to FIG. 1. FIG. 5 differs by spaced second end disks 13″ which are configured like short-circuit rings, as described above. Short-circuit rings 13′ are arranged in first fluid region 16. It is possible for the cooling fluid to circulate between the short-circuit rings, first end disk 13′, and rotor 11. In other words, it is possible for several ring-shaped flows to arise. The ring-shaped flows are parallel at least in sections. It is then possible to realize a larger effective cooling surface for second end disks 13″.

FIG. 6 corresponds substantially to FIG. 4. However, the hollow shaft cooling according to FIG. 6 comprises an oil, in particular, a dielectric oil, and the rotor cooling comprises a cooling gas, in particular air. Alternatively, other cooling fluids are possible.

FIG. 7 corresponds substantially to FIG. 6. FIG. 7 comprises an enlarged outlet 22. This makes it possible to guide the oil of the hollow shaft cooling and the air of the rotor cooling substantially in parallel without mixing. In the event that mixing of the cooling fluids is desired, a jet shape is alternatively possible.

FIG. 8 shows a combination of the e embodiments according to FIGS. 5 and 6. FIG. 8 comprises second end disks 13″ in the form of the spaced rings according to FIG. 5 and an outlet 22 for the cooling fluid of the hollow shaft cooling according to FIG. 6. Outlet 22 as well as the short-circuit rings are arranged in first fluid region 16. Oil therefore flows through the spaces between the short-circuit rings and the face side of rotor 11. However, air flows around first end disk 13′. The oil flow influences the circulating air flow or the ring-shaped flow around first end disk 13′ substantially only slightly or not at all.

FIG. 9 shows an embodiment which corresponds in structure substantially to FIG. 6. A channel 24 is arranged between rotor 11 and hollow shaft 15′, in particular in the laminated sheet package of rotor 11. Channel 24 extends in the axial direction. Channel 24 forms a fluid connection between the two axial ends of rotor 11.

The cooling fluid can circulate between two axial ends of rotor 11 through channel 24 and the gap between rotor 11 and stator 12. Air flows through channel 24 and the gap. The air flows through channel 24 to the left side of rotor 11 and through the gap to the right side of rotor 11. A reversal of the direction of flow is possible.

Inclination 22 of second end disk 13″ is arranged at one end of the gap. The air flows along inclination 22 and is deflected radially outwardly. This creates a further circulating flow around first end disk 13′ which runs parallel to the already existing circulating flow. More precisely, the further circulating flow encloses the already existing circulating flow. Inner fluid connection 19 is formed to be wider than in FIG. 6. Mixing of the cooling fluids is at least reduced in this manner.

FIG. 10 corresponds substantially to FIG. 8. Unlike in FIG. 8, second end disks 13″ comprise spacers 20. Spacers 20 are ring-shaped and arranged between second end disks 13″. More precisely, spacers 20 are arranged radially on the outside between second end disks 13″. Spacers 20 comprise hard plastic. Other materials are conceivable. Second end disks 13″ comprise passage openings which are each formed on the radially inner side of spacers 20. The spacers can be formed integrally with end disks 13′, 13″ or separately.

Spacers 20 enable a constant flow between second end disks 13″ and seal the gap between rotor 11 and stator 12 against the oil of the hollow shaft cooling.

FIG. 11 comprises an additional spacer which is arranged between first end disk 13′ and oppositely disposed second end disk 13″. First end disk 13′ comprises outer and inner fluid connection 18, 19. The additional spacer is arranged in the radial direction after outer fluid connection 18.

The additional spacer creates a bottleneck. The additional spacer enables selective mixing of the oil from the hollow shaft cooling and the air from the rotor cooling. Inner and/or outer fluid connection 18, 19 are then preferably configured as jets.

FIG. 12 shows an embodiment similar to FIG. 11. FIG. 12 comprises a spacer 20 which is arranged radially inwardly before inner fluid connection 19. The oil then flows only between rotor 11 and second end disks 13″. The oil and the air are merged only in the second fluid region. The oil can be transported away with the air vortex.

By arranging the spacer radially before the inner fluid connection, mixing of the oil of the hollow shaft cooling and the air of the rotor cooling is selectively prevented.

FIG. 13 shows a rotor 11 which is arranged on a hollow shaft. First end disks 13′ are arranged on the face sides of rotor 11 and are configured as balancing disks.

Balancing disk 13 is shown in detail in FIGS. 14A and 14B. Balancing disk 13 comprises an inclination 22 which rises in the direction of rotor 11. Balancing disk 13 further comprises bores which are arranged distributed over the circumference. The bores form inner fluid connection 19. A crown-shaped spacer formed integrally with balancing disk 13 is arranged on the side facing rotor 11. Starting from the central longitudinal axis, spacer 20 is arranged radially before the bores.

Hollow shaft 15′ comprises a supply line for a cooling fluid, in particular for a dielectric oil.

FIG. 15 shows a sectional view of an electric machine 10. Electric machine 10 comprises stator 12, rotor 11, first end disk 13′, several second end disks 13″, a hollow shaft 15′, and a fluid lance which is arranged in hollow shaft 15′. The structure of the electric machine corresponds substantially to that of FIG. 4.

The cooling lance protrudes up to the center of electric machine 10. The cooling lance is arranged on the central longitudinal axis of electric machine 10. Furthermore, the cooling lance has a supply opening for a cooling fluid in the region of the center of electric machine 10.

### LIST OF REFERENCE CHARACTERS

10 electric machine
11 rotor
12 stator
13 end disk
13′ first end disk
13″ second end disk
14 housing
15 shaft
15′ hollow shaft
16 fluid region
17 second fluid region
18 outer fluid connection
19 inner fluid connection
20 spacer
21 outlet opening
22 inclination
23 inlet opening
24 channel

1. Electric machine which is cooled or can be cooled by a fluid, comprising a rotor, a stator, and at least one end disk which are arranged in a housing, where said end disk and said rotor are arranged on a shaft, in particular a hollow shaft, and said end disk is arranged on at least one axial end of said rotor, wherein at least one first fluid region is formed between a first face side of said end disk and at least one axial end of said rotor and a second fluid region between a second face side of said end disk and said housing, where said two fluid regions comprise at least one outer fluid connection and at least one inner fluid connection which each connect said two fluid regions to one another such that said fluid can circulate at least in sections between said first and said second fluid region.

2. Electric machine according to claim 1, wherein said outer fluid connection has an annular gap which is defined by said end disk and an inner surface of said housing.

3. Electric machine according to claim 1, wherein said outer fluid connection is arranged in said end disk.

4. Electric machine according to claim 1, wherein said circulating fluid has an axial and/or radial direction at least in sections.

5. Electric machine according to claim 1, wherein said inner fluid connection extends at least in part between said face sides of said end disk.

6. Electric machine according to claim 1, wherein said shaft comprises a hollow shaft and said inner fluid connection extends at least in part in said hollow shaft.

7. Electric machine according to claim 1, wherein said hollow shaft comprises recesses, which are arranged in the circumferential direction on an outer surface of said hollow shaft in the region of said end disk.

8. Electric machine according to claim 1, wherein said electric machine comprises a first end disk and at least one second end disk, where said first end disk is configured as a balancing disk and said second end disk as a short-circuit ring.

9. Electric machine according to claim 8, wherein spacers are arranged between said first end disk, said rotor, and/or said second end disk.

10. Electric machine according to claim 1, wherein said inner fluid connection has different cross sections and/or cross-sectional shapes.

11. Electric machine according to claim 1, wherein a fluid flows through said hollow shaft which comprises at least one outlet opening in said first fluid region.

12. Electric machine according to claim 1, wherein said fluid comprises a cooling gas, and/or a cooling liquid.

13. Electric machine according to claim 8, wherein said first end disk and/or said second end disk comprise an inclination, where the incline of said inclination in the direction of said rotor is positive and the incline of said second end disk in the direction of said rotor is negative.

14. Electric machine according to claim 7, wherein said recesses comprise grooves.

15. Electric machine according to claim 8, wherein said second end disk comprises several stacked short-circuit rings.

16. Electric machine according to claim 12, wherein said cooling gas comprises air.

17. Electric machine according to claim 12, wherein said cooling liquid comprises dielectric oil.
